(19) United States
(12) Patent Application Publication
(10) Pub. No.: US 2022/0268041 A1
(43) Pub. Date: Aug. 25, 2022

(54) AN ADJUSTMENT SYSTEM, AN ADJUSTABLE SUPPORT, A METHOD OF ORIENTING AN ELEMENT, AND USE OF SUCH SYSTEM

(71) Applicant: I & P i NORR AB, Älvsbyn (SE)

(72) Inventors: Leif JOHANSSON, Kalix (SE); Anders HELIN, Älvsbyn (SE)

(73) Assignee: I & P i NORR AB, Älvsbyn (SE)

(21) Appl. No.: 17/630,755

(22) PCT Filed: Aug. 11, 2020
(86) PCT No.: PCT/EP2020/072494

§ 371 Date: Jan. 27, 2022

(30) Foreign Application Priority Data
Aug. 14, 2019 (SE) 1950930-6

(51) Int. Cl. E04G 21/18; E04G 21/16; B66F 3/18; B66F 3/46

(52) U.S. Cl. CPC E04G 21/1841; E04G 21/163; B66F 3/18; B66F 3/46

(57) ABSTRACT

An adjustment system including an adjustable support, a driving arrangement, a locking arrangement and a motor. The adjustable support includes a base including a bore having an open mouth; a screw being movable received in the bore while having a free end configured to project past the open mouth of the bore; and a driver being arranged in driving engagement with the screw, whereby a rotation of the driver results in a linear movement of the screw along the longitudinal extension of the bore. The driving arrangement includes a driver actuator arranged to be driven by the motor. Further, a method of orienting an element relative to a reference plane is provided.

### TECHNICAL FIELD

The present invention refers to an adjustment system, an adjustable support, a method of orienting an element, and also the use of such system to orient an element.

### TECHNICAL BACKGROUND

When erecting a new construction, a foundation is typically formed as a lower most structural part. The foundation may, depending on the type of construction, be formed by e.g. one or more pre-fabricated elements or modules which are arranged on the ground or on plinths. The elements or modules are typically fixated to the ground by concrete or filling material. It is essential that these elements are properly levelled as seen in the horizontal plane since any misalignment will cause angular deviations higher up in the construction. The very same issues apply equally in other, non-horizontal structural parts, such as vertical wall elements. This work is time consuming and also labor consuming since the element or module must be arranged on the pre-prepared ground and then its angular deviations in view of a reference plane must be determined by measuring. If any misalignment is determined, the element or module must be lifted anew and re-positioned. Before re-positioning any angular deviations must be corrected by arranging distances and/or removing material. Since the elements or modules typically are very heavy and handled in a lifted condition, there is also a risk of severe injuries to the personnel. There is hence a need to provide solution that facilitates the work and which thereby improves the quality, reduces the number of man hours and machinery hours required and accordingly also reduces the overall cost of the construction.

### SUMMARY

One object of the present invention is to provide an adjustable system that is easy to operate to provide a proper orientation of construction elements in view of a reference plane.

Another object is to provide a method allowing easy orientation of an element during construction work.

Another object is to provide a system and method that allows a reduced amount of time required to provide a proper orientation in view of a reference plane and hence allow an overall cost reduction.

These and other objects are solved by an adjustment system comprising an adjustable support, a driving arrangement, a locking arrangement and a motor, wherein

the adjustable support comprises a base comprising a bore having an open mouth; a screw being movable received in said bore while having a free end configured to project past said open mouth of the bore; and a driver being arranged in driving engagement with the screw, whereby an actuation of the driver results in a linear movement of the screw along the longitudinal extension of the bore; and wherein

said driving arrangement comprises a driver actuator arranged to be driven by the motor, wherein

the driving arrangement is integral with the motor and wherein the locking arrangement is configured to allow the driving arrangement to be removably connected to the base of the adjustable support; and wherein, as seen in a connected condition, the driver actuator is arranged in a driving engagement with the driver of said adjustable support to allow actuation of the driver; or

wherein

the driving arrangement is integral with the adjustable support and wherein the locking arrangement is configured to allow the motor to be removably connected to the driving arrangement, and wherein, as seen in a connected condition, the motor is arranged in a driving arrangement with the driver actuator of said driving arrangement to allow actuation of the driver.

In the context of the invention and the description to follow, the term “element” will be used. This may be any type of element. As non-limiting examples, the element may be a construction element to form part of a building, bridge or tunnel, or a machine element, such as a machine foundation or any support structure.

In the context of the invention and the description to follow below, the term “orienting” will be used. The term should be understood as orienting and positioning an element in view of a predetermined desired spatial position in view of a reference plane. The orienting may by way of example be made to provide a horizontal levelling of a floor element or a vertical orientation of a wall element. The orienting may also be made to provide any angle of an element in view of a horizontal reference plane.

Accordingly, the adjustment system comprises one unit intended for single use only and which is configured to be left as a permanent support to the element after orientation and one re-useable unit which is intended to be temporarily connected to the adjustable support during orientation of the element and then disconnected for further use. In a first embodiment, the adjustable support constitutes a single-use unit whereas the driving arrangement with an integral motor constitutes a re-usable unit. In a second alternative embodiment, the adjustable support with an integral driving arrangement constitutes a single-use unit whereas the motor constitutes a re-usable unit. No matter design, it is preferred that the locking arrangement is provided as a fast coupling type which may be operable without the need for any separate tooling. The system is easy operable on the field also in harsh climates and with gloves.

As given above, the single use unit may after completed orientation be left as a permanent support to the element and be embedded in e.g. concrete or filling material depending on the overall constructural design.

In the solution where the adjustable support is integral with the driving arrangement, the driver actuator will always be in engagement with the screw of the adjustable support, also after completed orientation and after removal of the motor. Thereby a self-locking effect is ensured which prevents un-screwing of the screw in the adjustable support without also operating the driver actuator. This may be seen as a safety measure.

The driver actuator may as a non-limiting example be a worm screw.

The skilled person will understand that the base and/or the screw of the adjustable support, no matter design, may be provided with an anchoring to allow fixation or integration of the adjustable support to the element and/or the base to the ground. A fixation to the element may be favorable in the event of non-horizontal elements.

In its most simple form, the system comprises one single adjustable support. This may by way of example be the case in the event the element in one end is resting on a fixed foundation whereby it may be sufficient to only adjust the other end of the element. Still, the skilled person will understand that the number of adjustable supports should be adapted to the type of element.

The adjustable support may be provided as an integral part of the element to be oriented. In the event the sensor arrangement comprises load sensors or angle sensors, it is to be understood that those may be an integral part of the element as well. The number of adjustable supports and their positions may thereby be optimized by the constructor or the supplier of the individual elements in view of the design and size of the element. The fixation of the adjustable supports to the element may e.g. be made by casting or bolting.

The base may on its bottom portion be provided with a foot providing an enlarged foot print.

In the embodiment when the driving arrangement is integral with the motor and the adjustable support is a stand-alone unit, the base may comprise a non-rotational symmetrical first engagement portion configured to allow the locking arrangement to removably connect the driving arrangement to the base; whereby in a connected condition, rotation between the base and the driving arrangement is prevented as seen in a plane extending transverse to the longitudinal extension of the screw.

The base may further, when the driving arrangement is integral with the motor and the adjustable support is a stand-alone unit, comprise a second engagement portion configured to allow the locking arrangement to removably connect the driving arrangement to the base, whereby in a connected condition, a displacement of the driving arrangement in view of the base in a direction along the longitudinal extension of the screw is prevented.

The first engagement portion may be seen as an anvil which prevents any rotational slippage between the base and the driving arrangement and hence rotation between the two parts. The second engagement portion may be seen as a longitudinal anvil which prevents any slippage in the longitudinal direction between the base and the driving arrangement and hence any longitudinal displacement between the two parts.

In an embodiment when the driving arrangement is integral with the adjustable support, the driver actuator may comprise a driver extending perpendicular to a longitudinal extension of the screw of the adjustable support.

The locking arrangement may be a threaded sleeve being concentric with the driver. A concentric engagement allows a linear movement to interconnect the two parts. The shaft of the motor may by way of example be axially inserted into a bore of the driver actuator or be arranged to axially encircle a free end portion of the driver actuator. The skilled person will however understand that the shaft of the motor with remained function may be radially displaced in view of the longitudinal extension of the driver by using an intermediate gear arrangement.

The system may further comprise a control unit, wherein the control unit is configured to be operably connected to the motor. The connection between the control unit and the motor may be either wired or wireless. In the event of a wireless connection, the motor may be powered by a rechargeable battery and be configured to be remotely controlled.

The system may further comprise a sensor arrangement, wherein said sensor arrangement is configured to be operably connected to the control unit, to the adjustable support or to the driving arrangement The operable connection may be wired or wireless. The sensor arrangement may be an arrangement suitable for orientation such as a laser or radar based system which as such is well known in the construction industry. In another example, the sensor arrangement may comprise a plurality of load sensors, where by the control unit is operated to provide an even load distribution across all sensors by operating the individual adjustable supports. The sensor arrangement may comprise one or more angle sensors configured to detect any angular deviations. It is to be understood that sensors of different types may be combined.

The motors in the respective driving arrangements may be remotely controlled by the control unit based on the input signals received from the sensor arrangement to thereby set the respective adjustable supports to accomplish a proper orientation of the element.

The system may comprise at least two adjustable supports and a corresponding number of driving arrangements each supporting a motor; or at least two adjustable supports, each comprising an integral driving arrangement and a corresponding number of motors. The system may even comprise a combination of the two types. The skilled person will understand that the number required may be decided based on the type of element to be oriented. By way of example, in the case of a beam to be arranged on a support having a known and acceptable position, one single set of an adjustable support and a driving arrangement and/or motor may be sufficient. In the case of a beam to be arranged on a ground, two sets of adjustable supports and a driving arrangements and/or motors may be useful, i.e. one set in each end of the beam. In yet another case, in the case of an element expanding a larger surface, three or more sets of adjustable supports and driving arrangements and/or motors may be useful. It is to be understood that more than four sets may be useful in the event the element has an inherent flexibility across its surface. In the latter case, it may be useful to use a sensor arrangement using load cells arranged on the adjustable supports, whereby the adjustable supports are operated to provide an even load distribution across all supports to thereby compensate for the inevitable deflection. Also angle sensors may be used in order of detecting any angular deviations.

According to another aspect, an adjustable support is provided. The adjustable support comprises a base, a screw and a driver, wherein

the base comprises a bore having an open mouth;

the screw is movable received in said bore while having a free end configured to project past said open mouth of the bore;

the driver is arranged to threadingly engage the screw, whereby an actuation of the driver results in a linear movement of the screw along the longitudinal extension of the bore; and wherein

the adjustable support is configured to be removably connected to a driving arrangement to allow actuation of the driver and hence cause the linear movement of the screw along the longitudinal extension of the bore; or

wherein

the adjustable support further comprises an integral driving arrangement which comprises a driver actuator operable connected to the driver to allow actuation of the driver and hence cause the linear movement of the screw along the longitudinal extension of the bore.

The adjustable support as such has been discussed above. To avoid undue repetition, reference is made to the arguments given above which arguments are equally and directly applicable also to the adjustable support as such.

In the embodiment where the driving arrangement is integral with the motor, the base may comprise a non-rotational symmetrical first engagement portion configured to allow the locking arrangement to removably connect the driving arrangement to the base; whereby in a connected condition, rotation between the base and the driving arrangement is prevented as seen in a plane extending transverse to the longitudinal extension of the screw.

The base may further comprise a second engagement portion configured to allow the locking arrangement to removably connect the driving arrangement to the base, whereby in a connected condition, a displacement of the driving arrangement in view of the base in a direction along the longitudinal extension of the screw is prevented.

The driver actuator may be concentric with the driver in the embodiment where the adjustable support comprises an integral driving arrangement.

According to another aspect, a method orienting an element relative to a reference plane is provided. The method comprises the acts of:

arranging one or more adjustable supports on the ground, the one or more adjustable supports being configured to support an element to be oriented or being integrated with an element to be oriented;

removably connecting a driving arrangement supporting a motor to each of the one or more adjustable supports; or removably connecting a motor to a driving arrangement of each of the one or more adjustable supports;

operatively connecting the respective driving arrangements to a control unit;

in the event the one or more adjustable supports being configured to support an element to be oriented, arranging an element to be oriented to the one or more adjustable supports;

determining, by using a sensor arrangement, an actual position of the element and communicating the determined actual position to the control unit;

comparing, by using the control unit, the determined actual position of the element with a predetermined set-point position of the element in view of a reference plane and determining a required adjustment of the element to reach said predetermined set-point position of the element, and

adjusting the position of the element by operating the respective driving arrangement by using the control unit to thereby adjust the longitudinal extension of the respective one or more adjustable supports required to meet the pre-determined set-point position of the element;

disconnecting the respective driving arrangement or motor from the respective one or more adjustable supports; and

leaving the respective one or more adjustable supports as a permanent fixed support to the oriented element.

Accordingly, a method is provided by which an element, no matter whether it is a longitudinally shaped item, such as a beam, or a plate having an enlarged surface extension, may be oriented in view of a reference plane. Depending on the number of adjustable supports, any deflection caused by the inherent weight and geometry may be compensated for by providing a larger amount of supports. After a proper orientation, the motor and or the driving arrangement supporting a motor is removed while leaving the adjustable support as a permanent support to the oriented element. The adjustable support may be embedded in e.g. concrete or other filling material.

The method is applicable for orienting an element in any direction. Thus, the invention is not restricted to levelling in the horizontal direction which is typically the case in e.g. a foundation, but also e.g. orientation in a vertical direction which is the case in e.g. when raising wall elements. Orientation in any angular extensions there between are equally applicable.

The adjustable support may be provided as an integral part of the element to be oriented, where by the act of arranging one or more adjustable supports on the ground also inherently includes arranging an element to be oriented to the one or more adjustable supports. Accordingly, the element may be supplied with one or more pre-mounted adjustable supports. In the event the sensor arrangement comprises load sensors or angle sensors, it is to be understood that those may be an integral part of such element as well.

According to another aspect, the invention refers to the use of said system to orient an element relative to a ground or a support. The orienting may be made in any direction. Thus, the invention is not restricted to levelling in the horizontal direction which is typically the case in e.g. a foundation, but also orientation e.g. in a vertical direction which is the case in e.g. when raising wall elements. Any angular extensions there between are equally applicable. The skilled person will understand that the base and/or the screw of the adjustable support may be provided with a fixation to allow fixation of the adjustable support to the element and/or the ground.

Further objects and advantages of the present invention will be obvious to a person skilled in the art reading the detailed description given below describing different embodiments.

### BRIEF DESCRIPTION OF THE DRAWINGS

The invention will be described in detail with reference to the schematic drawings.

FIG. 1 discloses one embodiment of an adjustment system in line with the invention together with an element to be oriented.

FIG. 2 discloses a perspective view of a first embodiment of an adjustable support to be used in the system.

FIG. 3 discloses a cross section of the adjustable support according to FIG. 2.

FIG. 4 discloses the base forming part of the adjustable support of FIG. 2.

FIG. 5 discloses the screw together with the driver and a guide forming part of the adjustable support of FIG. 2.

FIG. 6 discloses an exploded view of a first embodiment of a driving arrangement with an integrated motor.

FIG. 7 discloses the driving arrangement of FIG. 6 operatively connected to an adjustable support of FIG. 2.

FIG. 8. discloses a perspective view of a second embodiment of an adjustable support with an integrated driving arrangement and a motor to be connected thereto.

FIG. 9 discloses the second embodiment of the adjustable support with the housing removed.

FIG. 10 discloses a perspective view of the motor to be connected to the second embodiment of the adjustable support.

FIG. 11 discloses a perspective view of the second embodiment of the adjustable support connected to the motor of FIG. 10.

FIG. 12 is a flow chart disclosing a method of orienting an element by using the adjustment system of the invention.

### DETAILED DESCRIPTION

In the following description the overall design of one embodiment of the adjustment system will be discussed with reference to FIG. 1. In the disclosed embodiment the system 1 comprises three adjustable supports 100 (only two disclosed), each being operatively connected to a respective driving arrangement 200 with an integral motor 300. The driving arrangements 200 and/or the adjustable supports 100 are arranged in communication with a control unit 400. The communication is arranged by wires 401 extending between the respective driving arrangements 200 and the control unit 400. It is to be understood that the communication with remained function may be wireless.

A schematically disclosed element 2 to be oriented is supported by the three adjustable supports 100. Further, a schematically disclosed sensor arrangement 500 is arranged on top of the element 2. The sensor arrangement 500 is arranged in communication with the control unit 400. The sensor arrangement 500 may be arranged to communicate with the control unit 400 via a schematically disclosed wire 402. It is to be understood that the communication with remained function may be wireless. It is also to be understood that sensor arrangements in the form of load sensors and/or angle sensors (not disclosed) may be integrated in the adjustable supports 100.

Wireless communication between the different components and the control unit 400 may by way of example be made via a mobile communication system or via radio.

The control unit 400 may be a unit specifically designed to control the orienting with e.g. joystick, a key board or a touch screen proving a graphical user interface. It is also to be understood that the control unit 400 may be a smart phone or a tablet.

The control unit 400 comprises (not disclosed) at least a logic circuitry, an input device (not disclosed) and an output device (not disclosed) allowing the control unit 400 to communicate with the sensor arrangement 500. The logic circuitry may, in a manner well known to the skilled person, be arranged to comprise (not disclosed) a processor, a memory device, a FPGA (Field-Programmable Gate Array) or an ASIC (Application Specific Integrated Circuit). The logic circuitry may be arranged on a PCB (Printed Circuit Board).

The control unit 400 may be provided with a (non-disclosed) battery.

Depending of the complexity of the logic circuitry of the control unit 400, the control unit 400 may be configured to communicate with other devices via systems such as WiFi and NFC.

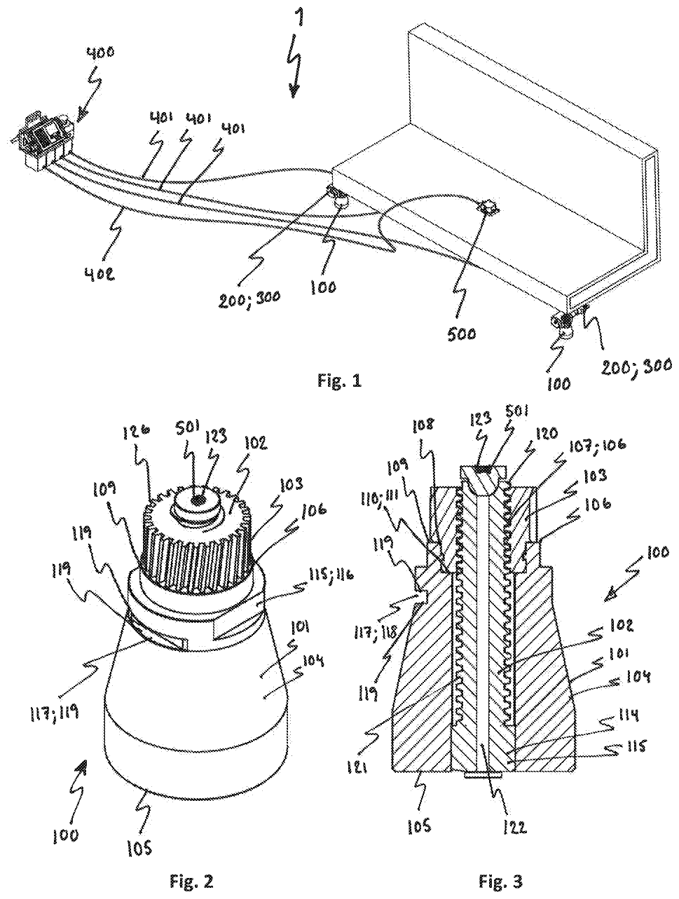

Now turning to FIGS. 2-5, a first embodiment of an adjustable support 100 is disclosed. The adjustable support 100 comprises a base 101, a screw 102 and a driver 103.

The base 101, best seen in FIGS. 2-4, comprises a body 104 having a preferably flat bottom surface 105 and a top surface 106. The bottom surface 105 may be provided with an enlarged non disclosed foot providing an enlarged foot print. A longitudinally extending bore 107 is arranged to extend into the base 101 starting from an open mouth 108 arranged on the top surface 106 thereof. In the disclosed embodiment the bore 107 is through-going. It is however it is to be understood that the bore 107 with remained function must not be through-going.

An upper free end portion of the base 101 in and around the mouth 108 comprises a first supporting surface 109 configured to form a first support for the driver 103 to be discussed below. Further, the mouth 108 comprises a recessed portion 110 having a bottom 111 forming a second support for the driver 103.

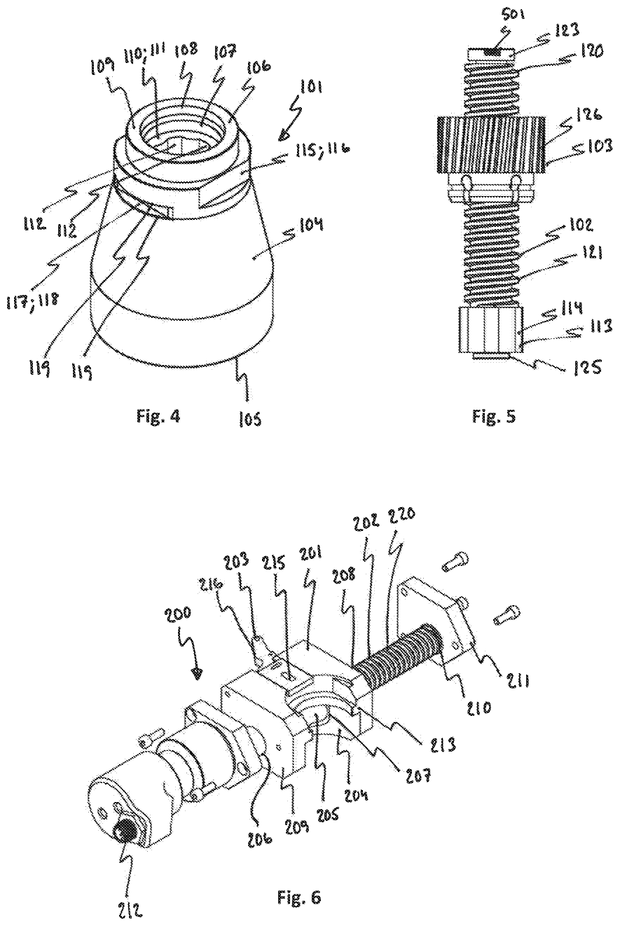

The inner envelope surface of the bore 107 comprises two or more longitudinally extending grooves 112, see FIG. 4. The grooves 112 are configured to engage complementary extending ridges 113 arranged on an exterior wall of a guide 114 arranged along a lower end portion 125 of the screw 102 to be described below with reference to FIG. 5.

The base 101 comprises a non-rotational symmetrical first engagement portion 115 configured to allow a removable connection between the adjustable support 100 and the driving arrangement 200 to be described below. In the disclosed embodiment the first engagement portion 115 is provided as two opposing flat surfaces 116 extending along the longitudinal extension of the bore 107. By the non-rotational symmetrical first engagement portion 115, any rotation between the base 101 and the driving arrangement 200 is prevented as seen in a plane extending transverse to the longitudinal extension of the screw 102 in a condition when the driving arrangement 200 is connected to the adjustable support 100.

Further, the base 101 comprises a second engagement portion 117 configured to allow a removable connection between the adjustable support 100 and the driving arrangement 200. In the disclosed embodiment, the second engagement portion 117 is provided as two opposing recesses 118 (only one disclosed) defined by upper and lower wall portions 119. Thereby, in a condition when the driving arrangement 200 is connected to the adjustable support 100, any displacement of the driving arrangement 200 in view of the base 101 in a direction along the longitudinal extension of the screw 102 is prevented.

The screw 102 is movable received in said bore 107 while having a free upper end 120 configured to project past said open mouth 108 of the bore 107. The screw 102 comprises a threaded portion 121 extending along a major part of the longitudinal extension of the screw 102.

In the disclosed embodiment, see FIG. 3, the screw 102 is provided with a longitudinally extending reinforcement 122 extending along the longitudinal center line of the screw 102. The reinforcement 122 is arranged to extend between the two opposing free ends of the screw 102, thereby strengthening the screw 102 in the axial direction thereof. A portion of the reinforcement 122 extends past the free upper end 120 of the screw 102 thereby forming a support surface 123 for an element 2 to be arranged on top of the adjustable support 100. Thereby, compressing load applied to the screw 102 by an element arranged thereon will be absorbed by the reinforcement 122 rather than by the screw 102. It is to be understood that the reinforcement 122 may be omitted with remained function, whereby the upper free end 120 of the screw 102 in such embodiment will form a support surface.

In the event the sensor arrangement 500 comprises a load sensor or an angle sensor, such sensor 501 may by way of example be arranged on said upper free end of the screw 102 or on the support surface 123. The communication between the sensor 501 and the control unit 400 may be wired or wireless. For facilitated illustration, any such wires have been omitted.

As given above, a lower end portion 125 of the screw 102 is provided with a guide 114 which is arranged in threaded arrangement with the screw 102. An exterior wall portion of the guide 114 is provided with longitudinally extending ridges 113 which are complementary to the two or more longitudinally extending grooves 112 of the bore 107, see FIG. 4. Thereby a guiding effect of the screw 102 is provided along the longitudinal extension of the bore 107.

As is best seen in FIGS. 2 and 3, the driver 103 is arranged to threadingly engage the upper end portion 120 of the screw 102. Hence, an actuation of the driver 103, such as rotation, results in a linear movement of the screw 102 along the longitudinal extension of the bore 107 while the screw 102 at the same time is guided inside the bore 107 by the guide 114 sliding against the grooves 112.

An outer envelope surface of the driver 103 comprises longitudinally extending teeth 126 configured to be arranged in a driving engagement with the driving arrangement 200 to be discussed below. The teeth 126 may form an angle to the longitudinal extension of the screw 102.

The first embodiment of the adjustable support 100 is intended to be a disposable unit that after completed orientation of the element 2 is configured to be left as a permanent support for the element 2 and encapsulated in e.g. soil, concrete, filling material or the like. It is therefore preferred that all parts of the adjustable support 100 are made of a non-corrosive material. The parts of the adjustable support 100 may be formed by a metal and/or a polymeric material. By way of example, the screw 102 may be made by a polymeric material while the reinforcement is made of a stainless steel.

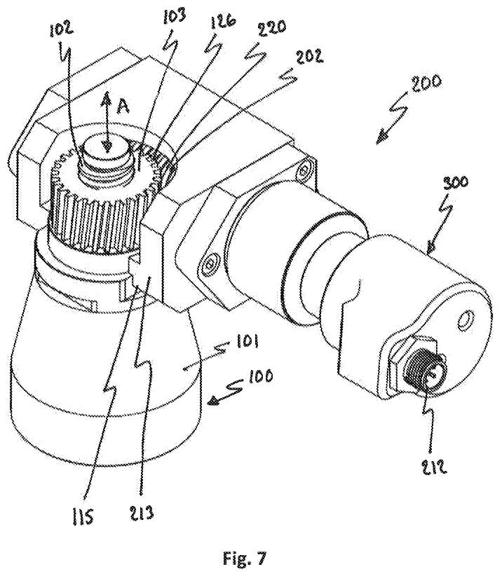

Now turning to FIGS. 6 and 7 a first embodiment of a driving arrangement 200 will be discussed. The driving arrangement 200 is configured to be removably connected to the first embodiment of the adjustable support 100 described above to allow actuation of the driver 103 and hence cause the linear movement of the screw 102 along the longitudinal extension of the bore 107.

Starting with FIG. 6, the driving arrangement 200 comprises a housing 201, a driver actuator 202 and a locking arrangement 203. FIG. 6 discloses a view of the driving arrangement 200 as seen from below. In the disclosed embodiment, the driver actuator 202 is arranged as a worm screw having an outer wall portion provided with threads 220.

The housing 201 comprises a recess 204 configured to radially encompass a portion of the driver 103 and a portion of the base 101 of the adjustable support 100. Further, the housing 201 comprises a through-going channel 205 configured to receive a threaded portion of the driver actuator 202 extending there through while being supported by a first support 206 and a second supports 207. In such position, see FIG. 7, a portion of the threads 220 of the driver actuator 202 is exposed in the recess 204 to allow a driving engagement between the threads 220 of the driver actuator 202 and the teeth 126 on the driver 103 of the adjustable support 100.

A first end 208 of the driver actuator 202 is arranged in driving arrangement 200 with the motor 300 which is supported by an exterior wall portion 209 of the housing 201. The motor 300 may be arranged by bolting to the housing 201.

The motor 300 comprises a non-disclosed driving shaft which is configured to rotatably engage the first end 208 of the driver actuator 202. The non-disclosed driving shaft of the motor 300 may be arranged to concentrically engage the driver actuator 202. Thus, in this first embodiment of the driving arrangement 200, the motor 300 is an integral part of the driving arrangement 200. A second end 210 of the driver actuator 202 is supported by a lid 211 configured to be bolted to the housing 201.

In the disclosed embodiment, the motor 300 is of the wired type with a socket 212 configured to allow a wired communication between the motor 300 and the control unit 400. The skilled person will understand that the socket 212 may be replaced by a non-disclosed communication unit allowing a wireless communication between the motor 300 and the control unit 400.

The motor may be powered by battery of by DC.

The driving arrangement 200 comprises a locking arrangement 203 configured to allow the driving arrangement 200 to lockingly engage the adjustable support 100. In the disclosed embodiment, see FIG. 6, the locking arrangement 203 comprises a shoulder 213 projecting from a wall portion 214 defining the recess 204. In a condition when the driving arrangement 200 is mounted to the base 101 of the adjustable support 100, the shoulder 213 will straddle and abut the non-rotational symmetrical first engagement portion 115 of the base 101. Thereby, in a condition when the driving arrangement 200 is connected to the adjustable support 100, any rotation between the base 101 and the driving arrangement 200 is prevented as seen in a plane extending transverse to the longitudinal extension of the screw 102 of the adjustable support 100.

Further, the locking arrangement 203 comprises a retractable disc 215 which is manually operable by a pivotable lever 216. By pivoting the lever 216, the disc 215 will be moved in the radial direction of the recess 204 in the housing 201 in and out of engagement with the second engagement portion 117 of the base 101. A portion of the disc 215 will thereby be received between the upper and lower wall portions 119 of the recess 118 forming the second engagement portion 117. Thereby, in a condition when the driving arrangement 200 is connected to the adjustable support 100, any displacement of the driving arrangement 200 in view of the base 101 in a direction along the longitudinal extension of the screw 102 of the adjustable support 100 is prevented.

Now turning to FIG. 7, the driving arrangement 200 of the first embodiment is disclosed as operable connected to an adjustable support 100 of the first embodiment discussed above. The threads 220 of the driver actuator 202 engages the teeth 126 of the driver 103. As the motor 300 is run, the driver actuator 202 will hence turn, whereby it will cause the driver 103 to actuate and thereby rotate the screw 102 of the adjustable support 100. Depending on the driving direction of the motor 300, the screw 102 of the adjustable support 100 will either be caused to be raised or be lowered, see arrow A.

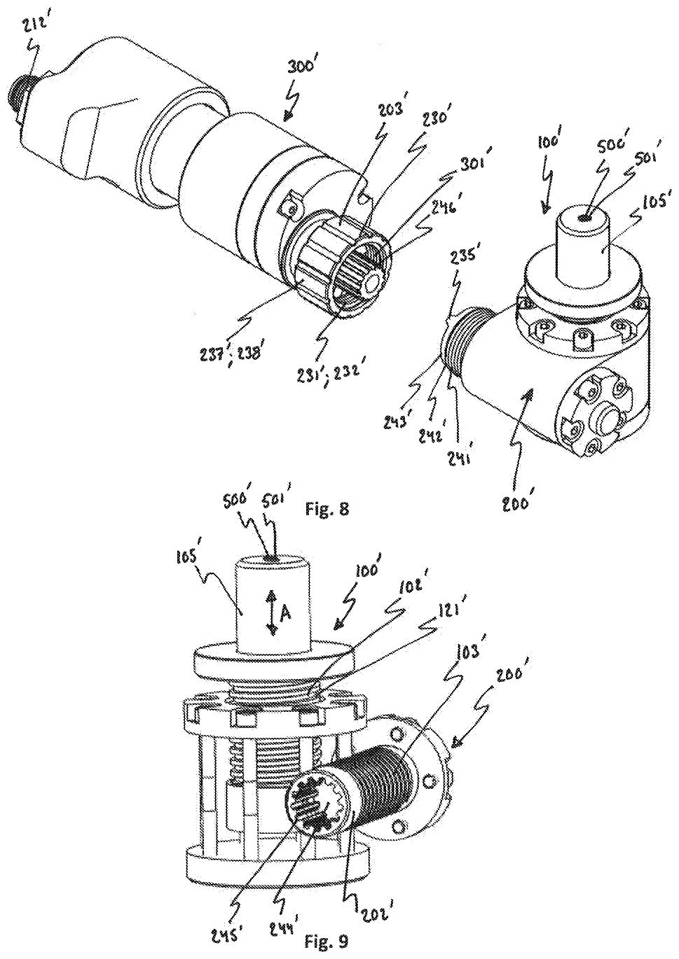

Now turning to FIGS. 8-11, a second embodiment of the adjustable support 100′ and the driving arrangement 200′ will be discussed. The second embodiment of the adjustable support 100′ differs from the first embodiment mainly in that the driving arrangement 200′ is integral with the adjustable support 100′ whereas the motor 300′ is configured to be removably connected to the driving arrangement 200′ of the adjustable support 100′. To facilitate the understanding, FIG. 8 discloses the motor 300′ separated from the adjustable support 100′. Also, FIG. 9 discloses the adjustable support 100′ without any housing.

Starting with FIG. 8, the motor 300′ comprises a socket 212′ configured to allow a wired communication between the motor 300′ and the control unit 400. The control unit may have the very same design as that previously discussed in view of the system and FIG. 1. The skilled person will understand that the socket 212′ may be replaced by a non-disclosed communication unit allowing a wireless communication between the motor 300′ and the control unit.

The motor 300′ is configured to be connected to the driving arrangement 200′ by a locking arrangement 203′ allowing a lockable and releasable engagement and connection between the shaft 301′ of the motor 300′ and the driving arrangement 200′ which is integral with the adjustable support 100′.

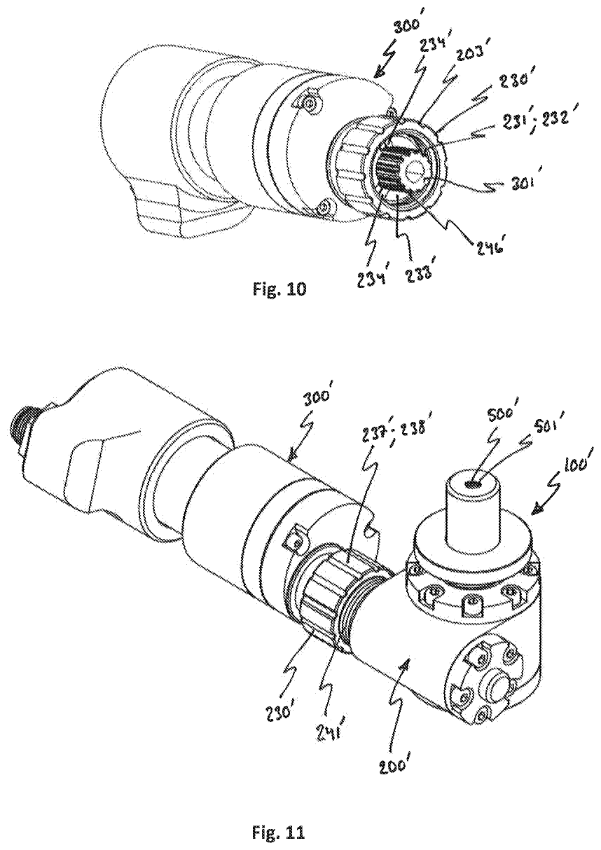

As is best seen in FIG. 10, the locking arrangement 203′ comprises a rotatable sleeve 230′ which is supported by the motor 300′. The sleeve 230′ comprises threads 231′ along its inner envelope surface 232′. Further, a bottom surface 233′ extending transverse the longitudinal axis of the shaft 301′ of the motor 300′ comprises at least one recess 234′ configured to engage a complementary projection 235′ of the driving arrangement 200′.

As is best seen in FIG. 9, the adjustable support 100′ of the second embodiment differs from the adjustable support 100 of the first embodiment in that the driver actuator 202′ is an integral part of the adjustable support 100′ and in rotatable engagement with the screw 102′ of the adjustable support 100′ via a threaded portion of the driver actuator 202′. The threaded portion forms a driver 103′. The driver actuator 202′ and hence the driver 103″extends perpendicular to the longitudinal extension of the screw 102′ of the adjustable support 100′. Thereby, a rotation of the driver actuator 202′ and hence the driver 103′ results in either raising or lowering of the screw 102′, see arrow A.

The screw 102′ is provided with an optional cap 105′. The cap 105′ constitutes a protection for the threads 121′ of the screw 102′. The cap 105′ may be embedded in the element 2 in the event the adjustable support 100′ should be pre-mounted to an element 2.

In the event the sensor arrangement 500 comprises a load sensor or an angle sensor, such sensor 501′ may by way of example be arranged on an upper free end of the cap 105′. In the event the cap 105′ is omitted, the sensor 501′ may instead be arranged on the screw 102′. No matter position, the communication between the sensor 501′ and the control unit may be wired or wireless. For the sake of facilitated illustration, any such wires have been omitted.

A front end 240′ of the driver actuator 202′, see FIG. 8 comprises an adaptor 241′. The adaptor 241′ comprises the at least one projection 235′ being complementary to the at least one recess 234′ of the rotatable sleeve 230′ of the driving arrangement 200′. Also, an exterior envelope surface 242′ of the adaptor 241′ is provided with threads 243′ complementary to those of the sleeve 230′ of the motor 300′.

Now turning to FIGS. 8 and 9. The driver actuator 202′ comprises, in its front end, a non-disclosed longitudinally extending bore 244′ with longitudinally extending grooves 245′ complementary to longitudinally extending ridges 246′ of the free end of the shaft 301′ of the motor 300′.

Now turning to FIG. 11, the motor 300′ is disclosed in a condition where it is operatively connected to the driving arrangement 200′ which as such is integral with the adjustable support 100′. In this condition, the free end of the shaft 301′ of the motor 300′ has been inserted into the corresponding longitudinally extending bore 244′ in the front end of the driver actuator 202′. In this position, the ridges 246′ of the free end of the shaft 301′ of the motor 300′ engages the complementary grooves 245′ of the bore 244′. Further, the at least one projection 235′ of the adaptor 241′ projects into the at least one recess 234′ in the bottom of the locking arrangement 203′ of the motor 300′. To secure this locking engagement, the sleeve 230′ is moved in the longitudinal direction towards the adaptor 241′ and is then rotated to threadingly engage the adaptor 241′. To enhance the gripping of the sleeve 230′, the exterior surface 237′ of the sleeve 230′ is provided with friction means 238′.

The motor 300′ may be connected to the driving arrangement 200′ of the adjustable support 100′ either before or after positioning an element 2 to be oriented on top of the screw 102′ of the adjustable support 100′.

After completed orientation of the element, the operator disconnects the motor 300′ by rotating the sleeve 230′ out of locking engagement with the adaptor 241′ and then moving the motor 300′ in the longitudinal direction away from the adjustable support 100′ and its integral driving arrangement 200′. The adjustable support 100′ together with the driving arrangement 200′ is configured to be left as a permanent support to the element and to be encapsulated in e.g. filling material or concrete. Accordingly, the adjustable support 100′ with its integral driving arrangement 200′ may be seen as a disposable, single use unit, while the motor 300′ on the other hand is designed to be reused. It is therefore preferred that all parts of the adjustable support 100′ and the driving arrangement 200′ are made of a non-corrosive material. The parts of the adjustable support 100 may be formed by a metal and/or a polymeric material.

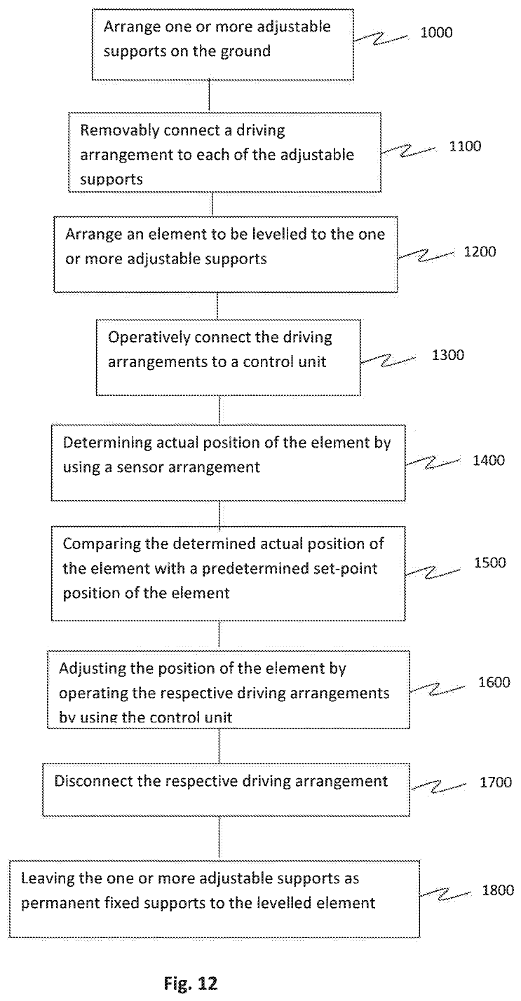

In the following, a method of orienting an element relative to a reference plane will be disclosed. Reference is made especially to FIGS. 1 and 12. The method will be described based on an element to be levelled horizontally. Hence, a horizontal reference plane will be used. It is to be understood that the method is equally applicable to any other direction of orientation or reference plane. Further, the method will be described based on an adjustable support 100 system in which the motor 300 is integral with the driving arrangement, thereby forming a standalone re-usable unit. Correspondingly, the adjustable support 100 will form a standalone unit. The adjustable support 100 system will have the same design as that previously discussed above with reference to FIGS. 2-5.

The method comprises the following acts:

As an initial act, step 1000, one or more adjustable supports 100 are arranged on the ground. The number of adjustable supports 100 are adapted to the type of element 2 to be oriented. The adjustable supports 100 are preferably evenly distributed across the surface or longitudinal extension of the element 2 to be oriented. In the disclosed embodiment three adjustable supports are provided.

As a next act, step 1100, a driving arrangement 200 supporting a motor 300 is removably connected to each of the adjustable supports 100. It is to be understood, that in the event the driving arrangement 200 instead is an integral unit with the adjustable support, step 1100 instead involves the act of removably connecting a motor 300′ to the driving arrangement 200′ of each of the one or more adjustable supports 100′.

As a next act, step 1200, the respective driving arrangement 200 is operatively connected to a control unit 400. How this is made in practice depends on the system configuration. In the event of a wired system, this may be made by connecting wires 401 between the respective driving arrangement 200 and the control unit 400. In case of a wireless system, this may instead be made by establishing a mobile or radio communication between the driving arrangement 200 and the control unit 400.

As a next act, step 1300, an element 2 to be oriented is arranged to the one or more adjustable supports 100. This may be made e.g. by a lifting crane.

As a next act, step 1400, an actual position of the element 2 is determined by using a sensor arrangement 500. The actual position is communicated to the control unit 400. Depending on the configuration of the system, this communication may be made by a wired communication between the sensor arrangement 500 and the control unit 400. Alternatively, it may be made by a wireless communication between the sensor arrangement 500 and the control unit 400. In the event of a wireless communication, this may be provided for by using mobile communication or radio communication. The sensor arrangement 500 may by way of example be based on one or more load sensors and/or angle sensors 501 or a laser based system. Even a combination of different types of sensors is possible. The sensor arrangement 500 may be configured to be operably connected to the control unit 400, to the adjustable support 100 or to the driving arrangement 200.

As a next act, step 1500, the determined actual position of the element 2 is compared, by using the control unit 400, with a predetermined set-point position of the element 2 in view of the reference plane. Further, a required adjustment of the element 2 to reach said predetermined set-point position of the element is determined.

As a next act, step 1600, the position of the element 2 is adjusted by operating the respective driving arrangement 200 by using the control unit 400. The adjustment involves adjusting the longitudinal extension of the respective one or more adjustable supports 100 which is required to meet the pre-determined set-point position of the element 2. The adjustment may be made based on a strict geometrical adjustment, i.e. by simply determining geometrical differences (x, y, z) in view of a set-point value. The adjustment may alternatively, or in combination with a geometrical adjustment be made based on detected load differences between load sensors 501 forming part of a sensor arrangement 500.

As a next step, step 1700, the respective driving arrangement 200 or motor 300 is disconnected from the respective one or more adjustable supports 100 or driving arrangements 200.

As a next and last act, step 1800, the respective one or more adjustable supports 100 are left as a permanent fixed support to the oriented element 2. Depending on the type of foundation, the adjustable supports may be encapsulated in e.g. concrete or filling material.

The skilled person will understand that the adjustable support may be provided as an integral part of the element. In such embodiment, it is understood that the act of arranging one or more adjustable supports on the ground also simultaneously includes arranging an element to the one or more adjustable supports. In the event the sensor arrangement comprises load sensors and/or angle sensors, it is to be understood that those may be an integral part of the supplied element as well. The number of adjustable supports and their positions may thereby be optimized by the supplier of the individual elements. The fixation of the adjustable supports may e.g. be made by casting or bolting.

No matter the first or second embodiments discussed above, the locking arrangement 203, 203′ provided may be seen as a fast coupling which is operable without any separate tooling. Thereby the system is easy operable on a construction site.

In the first embodiment, the locking engagement is provided by moving the driving arrangement 200′ into engagement with the adjustable support 100′ by a linear movement in a plane transverse the longitudinal extension or the screw 102, followed by pivoting the lever 216. In the second embodiment, the locking engagement is provided by moving the motor 300′ into engagement with the driving arrangement 200′ which is integral with the adjustable support 100′ by a strict linear movement and then rotating the sleeve 230′.

1. An adjustment system for orienting and positioning an element in view of a predetermined desired spatial position in view of a reference plane, comprising an adjustable single-use support, a driving arrangement, a locking arrangement and a motor, wherein
the adjustable support comprises a base comprising a bore having an open mouth; a screw being movable received in said bore while having a free end configured to project past said open mouth of the bore; and a driver being arranged in driving engagement with the screw, whereby an actuation of the driver results in a linear movement of the screw along the longitudinal extension of the bore; and wherein
said driving arrangement comprises a driver actuator arranged to be driven by the motor, wherein
the driving arrangement is integral with the motor and wherein the locking arrangement is a fast coupling configured to allow the driving arrangement to be temporarily and removably connected to the base of the adjustable support; and wherein, as seen in a connected condition, the driver actuator is arranged in a driving engagement with the driver of said adjustable support to allow actuation of the driver; or
wherein the driving arrangement is integral with the adjustable support and wherein the locking arrangement is a fast-coupling configured to allow the motor to be temporarily and removably connected to the driving arrangement and wherein, as seen in a connected condition, the motor is arranged in a driving engagement with the driver actuator of said driving arrangement to allow actuation of the driver.

2. The adjustment system according to claim 1, wherein when the driving arrangement is integral with the motor the base comprises a non-rotational symmetrical first engagement portion configured to allow the locking arrangement to removably connect the driving arrangement to the base; whereby in a connected condition, rotation between the base and the driving arrangement is prevented as seen in a plane extending transverse to the longitudinal extension of the screw; and/or
wherein the base further comprises a second engagement portion configured to allow the locking arrangement to removably connect the driving arrangement to the base, whereby in a connected condition, a displacement of the driving arrangement in view of the base in a direction along the longitudinal extension of the screw is prevented.

3. The adjustment system according to claim 1, wherein when the driving arrangement is integral with the adjustable support the driver actuator comprises a driver extending perpendicular to a longitudinal extension of the screw of the adjustable support.

4. The adjustment system of claim 3, wherein the locking arrangement is a threaded sleeve being concentric with the driver.

5. The adjustment system according to claim 1, further comprising a control unit wherein the control unit is configured to be operably connected to the motor.

6. The adjustment system according to claim 1, further comprising a sensor arrangement, wherein said sensor arrangement is configured to be operably connected to the control unit to the adjustable support or to the driving arrangement.

7. The adjustment system according to claim 1, wherein the system comprises at least two adjustable supports and a corresponding number of driving arrangements each supporting a motor or at least two adjustable supports each comprising an integral driving arrangement and a corresponding number of motors.

8. An adjustable single-use support for orienting and positioning an element in view of a predetermined desired spatial position in view of a reference plane, comprising a base, a screw and a driver, wherein
the base comprises a bore having an open mouth;
the screw is movable received in said bore while having a free end configured to project past said open mouth of the bore;
the driver is arranged to threadingly engage the screw, whereby an actuation of the driver results in a linear movement of the screw along the longitudinal extension of the bore; and wherein
the adjustable support is configured to be temporarily and removably connected to a driving arrangement to allow actuation of the driver and hence cause the linear movement of the screw along the longitudinal extension of the bore; or
wherein the adjustable support further comprises an integral driving arrangement which comprises a driver actuator operable connected to the driver to allow actuation of the driver and hence cause the linear movement of the screw along the longitudinal extension of the bore.

9. The adjustable support according to claim 8, wherein when the driving arrangement is integral with the motor the base comprises a non-rotational symmetrical first engagement portion configured to allow the locking arrangement to removably connect the driving arrangement to the base; whereby in a connected condition, rotation between the base and the driving arrangement is prevented as seen in a plane extending transverse to the longitudinal extension of the screw; and/or
wherein the base further comprises a second engagement portion configured to allow the locking arrangement to removably connect the driving arrangement to the base, whereby in a connected condition, a displacement of the driving arrangement in view of the base in a direction along the longitudinal extension of the screw is prevented.

10. The adjustable support according to claim 8, wherein the driver actuator is concentric with the driver.

11. Method of orienting and positioning an element in view of a predetermined desired spatial orientation in view of a reference plane, comprising the acts of:
arranging one or more adjustable single-use supports on the ground, the one or more adjustable supports being configured to support an element to be oriented or being integrated with an element to be oriented;
temporarily and removably connecting a driving arrangement supporting a motor to each of the one or more adjustable supports; or temporarily and removably connecting a motor to a driving arrangement of each of the one or more adjustable supports;
operatively connecting the respective driving arrangements to a control unit;
in the event the one or more adjustable supports being configured to support an element to be oriented, arranging an element to be oriented to the one or more adjustable supports;
determining, by using a sensor arrangement, an actual position of the element and communicating the determined actual position to the control unit;
comparing, by using the control unit the determined actual position of the element with a predetermined set-point position of the element in view of a reference plane and determining a required adjustment of the element to reach said predetermined set-point position of the element, and
adjusting the position of the element by operating the respective driving arrangement by using the control unit to thereby adjust the longitudinal extension of the respective one or more adjustable supports required to meet the pre-determined set-point position of the element;
disconnecting the respective driving arrangement or motor from the respective one or more adjustable supports; and
leaving the respective one or more adjustable supports as a permanent fixed support to the oriented element.

12. Use of a system according to claim 1 to orient and position an element relative to a ground or a support.
